(19) United States
(12) Patent Application Publication
(10) Pub. No.: US 2025/0074158 A1
(43) Pub. Date: Mar. 6, 2025

(54) Cooling Arrangement for Conditioning Cabins of Work Machines

(71) Applicant: Caterpillar Underground Mining Pty. Ltd., South Burnie (AU)

(72) Inventors: Karthik Raja MUTHUSAMY, Mudukkarai (IN); Sivakumar Ramasamy, Tamil Nadu (IN); Praveen Kumar Ravi, Chennai (IN); Sean Robert Saward, Penguin (AU)

(73) Assignee: Caaterpillar Underground Mining Pty. Ltd., South Burnie (AU)

(21) Appl. No.: 18/821,323

(22) Filed: Aug. 30, 2024

(30) Foreign Application Priority Data
Aug. 31, 2023 (AU) 2023222913

(51) Int. Cl. B60H 1/32; B60H 1/00

(52) U.S. Cl. CPC B60H 1/32281; B60H 1/00385; B60H 1/3202; B60H 2001/00949

(57) ABSTRACT

A cooling arrangement for conditioning air within a cabin of an underground work machine includes blowers to generate an air flow, a first evaporator, and a second evaporator. The first evaporator provides passage to a first portion of the air flow and receive a first coolant to facilitate a first heat transfer from the first portion of the air flow to the first coolant. The second evaporator provides passage to a second portion of the air flow and receive a second coolant to facilitate a second heat transfer from the second portion of the air flow to the second coolant. A receipt of the first coolant into the first evaporator for the first transfer and a receipt of the second coolant into the second evaporator for the second transfer occurs either independently or simultaneously with each other for supplying conditioned air flow into the cabin to cool the cabin.

### TECHNICAL FIELD

The present disclosure relates generally to work machines, such as underground work machines. More particularly, the present disclosure relates to an air conditioning system having dual cooling circuits with corresponding dual evaporators for cooling and conditioning a cabin of a work machine.

### BACKGROUND

Machines, such as underground work machines, operate generally under rigorous and harsh conditions of an underground work environment, e.g., of an underground mining environment. As an example, an underground work environment may include hot and/or humid weather conditions. To keep operators stationed in such machines (e.g., within an operator cabin of such machines) relatively comfortable in such weather conditions, an air conditioning system may be used, and which may be powered by a prime mover, such as an internal combustion engine, of the corresponding machine.

Operations at the underground work environment may require that the internal combustion engine be switched (e.g., repeatedly switched) between an active state and an inactive state. As an example, when the machine is stationary (e.g., to receive a payload in case the machine includes an articulated dump truck), the internal combustion engine may be turned off or moved to the inactive state to be prevented from idling and thus from consuming fuel during the payload transfer. However, with the deactivation of the internal combustion engine, the air conditioning system, if powered by the internal combustion engine, may be deactivated, as well.

Chinese Patent No.: 216684005 relates to a flow-priority open-air drilling machine hydraulic air-conditioning system and a double-air-conditioning drilling machine. The hydraulic air conditioning system comprises a first compressor, a first condenser and a first evaporator and further comprises a hydraulic power module. The double-air-conditioner drilling machine comprises an original air-conditioner system of the drilling machine and the open-air drilling machine hydraulic air-conditioner system with a priority flow. The refrigerating efficiency is improved through the double systems, and the double-air-conditioner drilling machine is suitable for high-temperature areas.

### SUMMARY OF THE INVENTION

In one aspect, the disclosure relates to a cooling arrangement for conditioning air within a cabin of an underground work machine. The cooling arrangement includes one or more blowers to generate an air flow, a first evaporator, and a second evaporator. The first evaporator is configured to provide passage to a first portion of the air flow and receive a first coolant from a first cooling circuit to facilitate a first heat transfer from the first portion of the air flow to the first coolant as the first portion of the air flow passes through the first evaporator. The second evaporator is configured to provide passage to a second portion of the air flow and receive a second coolant from a second cooling circuit different from the first cooling circuit to facilitate a second heat transfer from the second portion of the air flow to the second coolant as the second portion of the air flow passes through the second evaporator. A receipt of the first coolant into the first evaporator to facilitate the first transfer and a receipt of the second coolant into the second evaporator to facilitate the second transfer occurs either independently of each other or simultaneously with each other for supplying conditioned air flow into the cabin to cool the cabin.

In another aspect, the disclosure is directed to an air conditioning system for a cabin of an underground work machine. The air conditioning system includes a first cooling circuit to route a first coolant, a second cooling circuit to route a second coolant, and a cooling arrangement. The cooling arrangement conditions air within the cabin of the underground work machine. The cooling arrangement includes one or more blowers to generate an air flow, a first evaporator, and a second evaporator. The first evaporator is configured to provide passage to a first portion of the air flow and receive the first coolant to facilitate a first heat transfer from the first portion of the air flow to the first coolant as the first portion of the air flow passes through the first evaporator. The second evaporator is configured to provide passage to a second portion of the air flow and receive the second coolant to facilitate a second heat transfer from the second portion of the air flow to the second coolant as the second portion of the air flow passes through the second evaporator. A receipt of the first coolant into the first evaporator to facilitate the first transfer and a receipt of the second coolant into the second evaporator to facilitate the second transfer occurs either independently of each other or simultaneously with each other for supplying conditioned air flow into the cabin to cool the cabin.

In yet another aspect, the disclosure relates to an underground work machine. The underground work machine includes a main frame, a cabin supported on the main frame and configured to station one or more operators therein, and an air conditioning system for the cabin. The air conditioning system includes a first cooling circuit to route a first coolant, a second cooling circuit to route a second coolant—the second cooling circuit is different from the first cooling circuit. The air conditioning system also includes a cooling arrangement for conditioning air within the cabin. The cooling arrangement includes one or more blowers to generate an air flow, a first evaporator, and a second evaporator. The first evaporator is configured to provide passage to a first portion of the air flow and receive the first coolant to facilitate a first heat transfer from the first portion of the air flow to the first coolant as the first portion of the air flow passes through the first evaporator. The second evaporator is configured to provide passage to a second portion of the air flow and receive the second coolant to facilitate a second heat transfer from the second portion of the air flow to the second coolant as the second portion of the air flow passes through the second evaporator. A receipt of the first coolant into the first evaporator to facilitate the first transfer and a receipt of the second coolant into the second evaporator to facilitate the second transfer occurs either independently of each other or simultaneously with each other for supplying conditioned air flow into the cabin to cool the cabin.

### BRIEF DESCRIPTION OF THE DRAWINGS

FIG. 1 is a side view of an exemplary underground work machine having an air conditioning system, in accordance with one or more aspects of the present disclosure; and

FIG. 2 is a schematic view of the air conditioning system having a first cooling system and a second cooling system, in accordance with one or more aspects of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

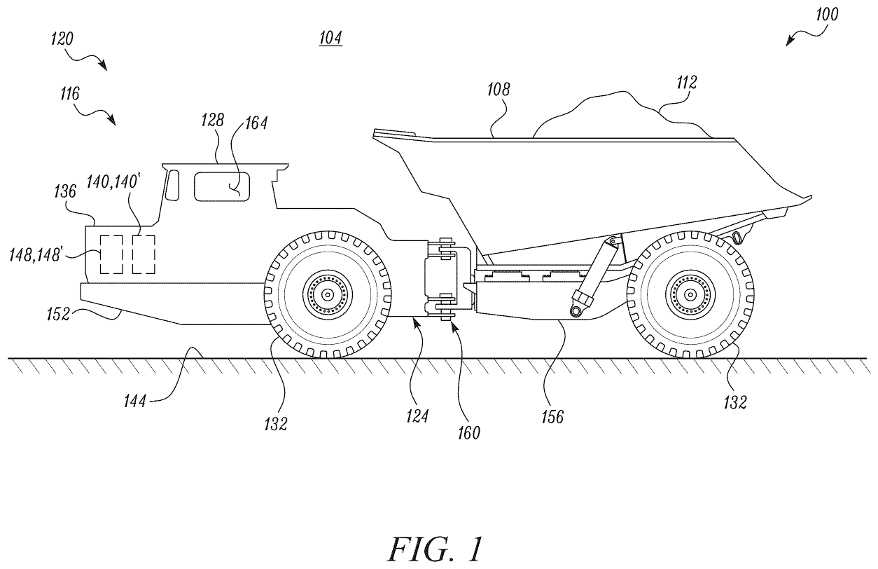

Referring to FIG. 1, an exemplary work machine, i.e., a work machine 100, is shown. The work machine 100 may be operable at a worksite 104 and may be configured to repeatedly traverse back and forth between and/or relative to various locations on the worksite 104. As an example, the work machine 100 may include a dump body 108 which may be used to carry and/or transfer a payload 112 from one location of the worksite 104 to another location of the worksite 104. Such locations of the worksite 104 may include load locations from where the work machine 100 (e.g., the dump body 108 of the work machine 100) may receive the payload 112 and dump locations up to where the work machine 100 may traverse to so as to release and dump the payload 112 from the dump body 108. Examples of the worksite 104 may include, but not limited to, a construction site, a mine site, a landfill, a quarry, an underground mine site, etc.

In one exemplary embodiment of the present disclosure, the work machine 100 includes an underground work machine 116 such as a dump truck or an underground articulated dump truck 120, which is commonly employed and operated at mine sites, e.g., underground mine sites, for the transfer and/or delivery of materials, such as ores and minerals. However, aspects of the present disclosure may be applied to several other work machines. For example, aspects of the present disclosure also may be applicable to various other mobile work machines which may include one or more operator cabins. Not limiting examples of such machines may include construction machines and/or mining machines, such as loaders, excavators, shovels, graders, scrapers, mining trucks, off-highway trucks, and/or the like. Therefore, it will be appreciated that references to the work machine having the dump body and/or to the underground work machine 116 is purely exemplary. For ease of reference, the work machine 100 may, hereinafter, simply be referred to as a machine 100.

The machine 100 may include a main frame 124, an operator cabin 128, one or more traction devices 132. The machine 100 may also include several other parts and sub-systems, such as a power compartment 136 that may house a first energy source 140 or a main power source (e.g., an internal combustion engine 140′) of the machine 100 for powering various functions of the machine 100, including propelling the machine 100 over a ground surface 144 of the worksite 104 and/or actuating one or more implements (e.g., the dump body 108) of the machine 100. In some embodiments, the power compartment 136 may also include a second energy source 148 (different from the first energy source 140) or an auxiliary power source, e.g., an electrical energy source 148′ that may include a battery.

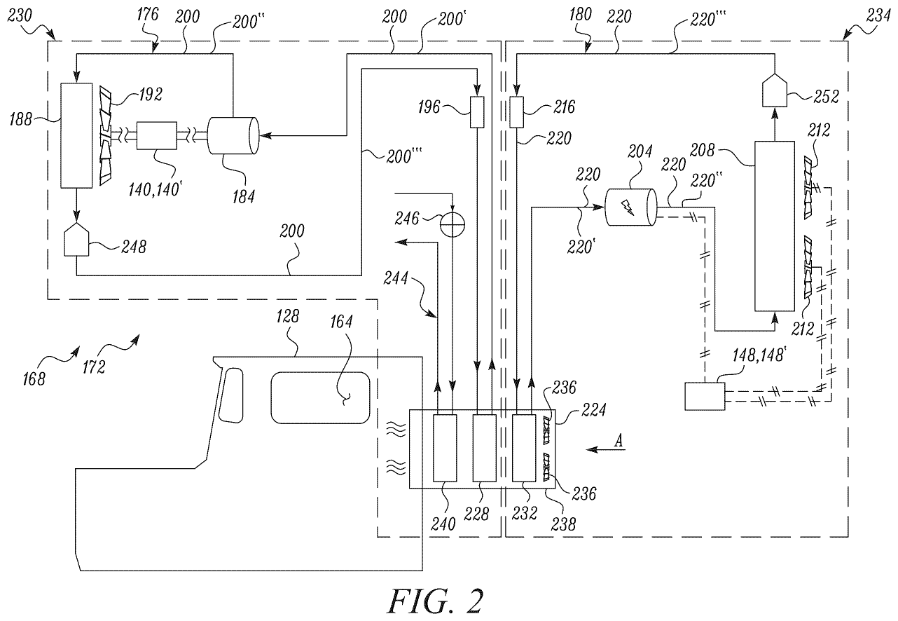

Referring to FIGS. 1 and 2, the main frame 124 may include a rigid structure to which nearly every other component (and/or sub-component) of the machine 100 may be coupled to. If the machine 100 were to include an articulated machine, such as the underground articulated dump truck 120, as exemplarily shown, it may be contemplated that the main frame 124 may include a split frame configuration including a forward sub-frame portion 152 and a rearward sub-frame portion 156. The forward sub-frame portion 152 may be pivotably coupled to the rearward sub-frame portion 156 by a hitch 160 at a hitch location. By way of the hitch 160, the forward sub-frame portion 152 of the main frame 124 may pivot or articulate relative to the rearward sub-frame portion 156 of the main frame 124, during machine movement.

As an example, the forward sub-frame portion 152 may support the power compartment 136 housing the main power source (e.g., the internal combustion engine 140′) of the machine 100, while the rearward sub-frame portion 156 may support the dump body 108 of the machine 100. The dump body 108 may be pivotably coupled to the forward sub-frame portion 152 by way of the hitch 160. Although not limited, the rearward sub-frame portion 156 can include a configuration similar to that of a ladder frame layout to support the dump body 108 and the payload 112 receivable therein.

The operator cabin 128 may be supported by the forward sub-frame portion 152 of the main frame 124 of the machine 100, although various other locations of the operator cabin 128 may be contemplated. The operator cabin 128 may define an interior volume 164 which may house various parts and systems, such as controls, etc., of the machine 100. The operator cabin 128 may be also used to accommodate/station one or more operators (not shown) of the machine 100 for the control of one or more functions of the machine 100. The operator cabin 128 may include an operator interface, including one or more of a display unit, a control panel, a touchscreen, and/or the like, (not shown) that may be accessed by one or more operators of the machine 100 so as to feed input related to a functioning of the machine 100.

Referring to FIG. 2, and according to some embodiments of the present disclosure, the machine 100 may include an air conditioning system 168 for the operator cabin 128. The air conditioning system 168 may include an HVAC (Heating Ventilation and Cooling) system 172. More particularly, the air conditioning system 168 may include a first cooling circuit 176 and a second cooling circuit 180. Both the first cooling circuit 176 and the second cooling circuit 180 may include a number of components. As an example, the first cooling circuit 176 may include a first compressor 184, a first condenser 188, a first condenser fan set 192, a first expansion valve 196, and multiple corresponding coolant lines 200 that may route or provide passage to a coolant (e.g., a first coolant) through one or more of the aforementioned components of the first cooling circuit 176. Similarly, the second cooling circuit 180 may include a second compressor 204, a second condenser 208, a second condenser fan set 212, a second expansion valve 216, and multiple corresponding coolant lines 220 that may route or provide passage to a coolant (e.g., a second coolant) through one or more of the aforementioned components of the second cooling circuit 180.

One or more components of the first cooling circuit 176 may be powered or run by the first energy source 140 (e.g., by the internal combustion engine 140′). As an example, the first compressor 184 and the first condenser fan set 192 may be powered or run by the first energy source 140. The first condenser fan set 192 may be used to urge an air flow (e.g., by either pushing or pulling the air flow) through and across the first condenser 188. Similarly, one or more components of the second cooling circuit 180 may be powered or run by the second energy source 148 (e.g., by the electrical energy source 148′ or the battery). As an example, the second compressor 204 and the second condenser fan set 212 may be powered or run by the second energy source 148, instead of the first energy source 140. The second condenser fan set 212 may be used to urge the air flow (e.g., by either pushing or pulling the air flow) through and across the second condenser 208. An exemplary functional layout and working of each of the first cooling circuit 176 and the second cooling circuit 180 shall be described later in the present disclosure.

The air conditioning system 168 may also include a cooling arrangement 224. The cooling arrangement 224 may include multiple evaporators, namely a first evaporator 228 and a second evaporator 232, as shown, and which may respectively work in concert with the first cooling circuit 176 and the second cooling circuit 180 to condition (e.g., to cool or lower the temperature of) the operator cabin 128. More particularly, the first evaporator 228 may correspond to and work in conjunction with the first cooling circuit 176 and thus may receive the first coolant (e.g., a cooled down first coolant) from the first cooling circuit 176 during operations of the air conditioning system 168. Similarly, the second evaporator 232 may correspond to and work in conjunction with the second cooling circuit 180 and thus may receive the second coolant (e.g., a cooled down second coolant) from the second cooling circuit 180 during operations of the air conditioning system 168.

Although the first evaporator 228 and the second evaporator 232 are discussed or described as part of the cooling arrangement 224, in some embodiments, the first evaporator 228 may be a part of a first cooling system 230 of the air conditioning system 168 which may also include the first cooling circuit 176. Similarly, the second evaporator 232 may be a part of a second cooling system 234 of the air conditioning system 168 which may also include the second cooling circuit 180. In brevity, the air conditioning system 168 may include (or be formed by) the first cooling system 230 and the second cooling system 234.

The cooling arrangement 224 may also include one or more blowers 236. The blowers 236 may be configured to generate an air flow (see direction, A). The air flow, as generated by the blowers 236, may be forced to pass (e.g., by forced convection) through each of the first evaporator 228 and the second evaporator 232. In some embodiments, the blowers 236 may be positioned in an immediate vicinity of the first evaporator 228 and the second evaporator 232 to force the air flow to pass through each of the first evaporator 228 and the second evaporator 232. In some embodiments, the blowers 236 associated with the first evaporator 228 and the second evaporator 232 may be driven by one or more of the main power source (e.g., the first energy source 140) and/or the auxiliary power source (e.g., the second energy source 148) and/or by any other power source accessible to the machine 100.

By way of forcing the air flow (see direction, A) through the first evaporator 228 and the second evaporator 232, the first evaporator 228 and the second evaporator 232 may facilitate a transfer of heat from the passing air flow onto the first coolant (e.g., the cooled down first coolant) and/or the second coolant (e.g., the cooled down second coolant) which may respectively pass through the first evaporator 228 and the second evaporator 232, thereby increasing the temperature of the first coolant and/or the second coolant and correspondingly turning them into a first coolant vapor form and/or a second coolant vapor form. Simultaneously, or in concomitance, the portions of the air flow passing through the first evaporator 228 and/or the second evaporator 232 may be lowered in temperature or said portions of the air flow may be cooled down which may be then routed into the interior volume 164 of the operator cabin 128 to condition and/or to cool the interior volume 164 of the operator cabin 128.

In some embodiments, the first evaporator 228 and the second evaporator 232 may be arranged serially with respect to each other. In so doing, the air flow from the blowers 236 may sequentially pass through each of the first evaporator 228 and the second evaporator 232. In some embodiments, the first evaporator 228 may be positioned downstream to the second evaporator 232 along a direction of the air flow (see direction, A) generated by the blowers 236. In some embodiments, the first evaporator 228 can be conversely, or alternatively, positioned upstream to the second evaporator 232 along the direction of the air flow generated by the blowers 236 (see direction, A).

Effectively, the first evaporator 228 is configured to provide passage to a first portion of the air flow (see direction, A) and receive the first coolant from the first cooling circuit 176 to facilitate a first heat transfer from the first portion of the air flow to the first coolant as the first portion of the air flow passes through the first evaporator 228. Similarly, the second evaporator 232 is configured to provide passage to a second portion of the air flow (see direction, A) and receive the second coolant from the second cooling circuit 180 to facilitate a second heat transfer from the second portion of the air flow to the second coolant as the second portion of the air flow passes through the second evaporator 232. It may be apparent that the second cooling circuit 180 may be different from the first cooling circuit 176. The second coolant may be different from the first coolant as well, although, in some embodiments, it is possible that the second coolant be one and the same as the first coolant.

The terms ‘first’ and ‘second’ used for the expressions ‘first portion’ of the fluid flow and the ‘second portion’ of the fluid flow are to merely represent different fluid flow portions which may be respectively generated by the blowers 236 and passed through the first evaporator 228 and the second evaporator 232 at different instances, e.g., when in each such instance only one of the first cooling circuit 176 (and the first evaporator 228) or the second cooling circuit 180 (and the second evaporator 232) is active. Therefore, said terms ‘first portion’ and ‘second portion’ need not necessarily be viewed as chronological stages of any cooling process of the air conditioning system 168. Nonetheless, in exemplary cases where the first cooling circuit 176 and the second cooling circuit 180 (and thus the first evaporator 228 and the second evaporator 232) may both be operational at the same time to cool the operator cabin 128, a volume defined by each of the first portion of the air flow and the second portion of the fluid flow can be one and the same, e.g., if sizes or capacities of the first evaporator 228 and the second evaporator 232 are the same.

It may be noted that the first evaporator 228 and the second evaporator 232 may belong to different cooling systems (e.g., first cooling system 230 and second cooling system 234) or cooling circuits (e.g., the first cooling circuit 176 and the second cooling circuit 180) but may be integrated into a common confinement or structure (e.g., see structure 238) so as to be space efficient within the limited confines of the interior volume 164 of the operator cabin 128. Also, it will be appreciated that a receipt of the first coolant into the first evaporator 228 to facilitate the first transfer and a receipt of the second coolant into the second evaporator 232 to facilitate the second transfer can occur either independently of each other or simultaneously with each other for the supply of conditioned air flow (e.g., cooled air flow) into the interior volume 164 of the operator cabin 128 to cool said interior volume 164 of the operator cabin 128.

In some embodiments, the cooling arrangement 224 may also include one or more heat exchangers (e.g., see heat exchanger 240) configured to receive a third coolant correspondingly from one or more heating circuits (e.g., heating circuit 244) to selectively heat the air flow as the air flow generated by the blowers 236 may pass therethrough. As an example, such heating may be carried out in an inactive state of each of the first cooling system 230 (or the first cooling circuit 176 and the first evaporator 228) and the second cooling system 234 (or the second cooling circuit 180 and the second evaporator 232). Moreover, a flow of the third coolant into the heat exchanger 240 may be regulated by a heater valve 246. According to some embodiments, the heat exchanger 240 may be positioned downstream of the first evaporator 228 along the direction of the air flow (see direction, A) generated by the blowers 236.

According to some embodiments, the heat exchanger 240 may be positioned downstream of each of the first evaporator 228 and the second evaporator 232 along the direction of the air flow (see direction, A) generated by the blowers 236. A downstream positioning of the heat exchanger 240 with respect to the first evaporator 228 and the second evaporator 232 may allow the elements, such as fins (not shown), of the heat exchanger 240 to trap water molecules that may be present in the air flow (see direction, A) flowing in from the one or more of the first evaporator 228 and the second evaporator 232 and which then passes through the heat exchanger 240. In that manner, an air flow with reduced moisture levels may be introduced into the interior volume 164 of the operator cabin 128, thus helping keep humidity levels within the interior volume 164 of the operator cabin 128 in check or in control.

### INDUSTRIAL APPLICABILITY

With regard to a working of the first cooling system 230, the first cooling system 230 of the air conditioning system 168 may facilitate or urge passage of the first coolant through (e.g., sequentially through) a cycle of compression, condensation, expansion, and evaporation. In so doing, a conditioned air flow (e.g., a cooled air flow) may be generated, e.g., at the first evaporator 228, and then said cooled air flow may be supplied into the interior volume 164 of the operator cabin 128, and accordingly, a temperature within the interior volume 164 of the operator cabin 128 may be reduced and accordingly conditioned.

To this end, during operations, the first compressor 184 may be driven or powered by the first energy source 140 or the internal combustion engine 140′ of the machine 100, and may receive the first coolant (e.g., in a vaporized form) from line 200′. The first compressor 184 may compress or pressurize the first coolant up to a suitable pressure. Then, the first condenser 188 may receive the pressurized or compressed first coolant from the first compressor 184 through line 200″ and may function to condense the pressurized or compressed first coolant, e.g., to either a liquid phase or a saturated liquid-vapor phase. The condensation at the first condenser 188 may occur as an air flow, generated by the first condenser fan set 192, may pass through and across the first condenser 188. Also, as with the first compressor 184, the first condenser fan set 192 may be driven or powered by the first energy source 140 or the internal combustion engine 140′.

The first expansion valve 196 may receive the condensed first coolant from the first condenser 188 through line 200′″ and may expand the condensed first coolant to lower a temperature of the first coolant at the first expansion valve 196, thus cooling down the condensed first coolant. A resulting expanded first coolant may be then received by the first evaporator 228 of the cooling arrangement 224. As the first evaporator 228 may also receive the air flow from the blowers 236 (see direction, A), the first evaporator 228 may function to evaporate or vaporize the expanded first coolant, in turn allowing the vaporized first coolant to carry heat energy away from the air flow (or from the first portion of the air flow) passing through the first evaporator 228. In some embodiments, a drier (e.g., a first drier 248) may be present or included in the first cooling circuit 176. The first drier 248 may be configured to remove or reduce moisture present in the first coolant before the first coolant moves into the first expansion valve 196.

With regard to the first evaporator 228, as heat energy may be carried away by the vaporized first coolant from the air flow, an ensuing cooled air flow may be generated at the first evaporator 228. This cooled air flow may be routed and supplied to the interior volume 164 of the operator cabin 128 for lowering the temperature of the operator cabin 128. In some embodiments, the cooled air flow generated at the first evaporator 228 may be sourced from the air present with the interior volume 164 of the operator cabin 128 itself. In other words, air sourced from the interior volume 164 of the operator cabin 128 may be forced through the first evaporator 228 for the generation of the cooled air flow, and the said cooled air flow, as delivered into the operator cabin 128, may be further recirculated and drawn back (e.g., by a continuous working action of the blowers 236) into the first evaporator 228 such that the cooled air can further undergo (e.g., repeatedly undergo) cooling at the first evaporator 228. By way of such recirculation of cabin air, air within the interior volume 164 of the operator cabin 128 can be cooled and/or conditioned.

It may be noted that the vaporized volume of the first coolant generated at the first evaporator 228 (in concomitance to the generation of the cooled air flow at the first evaporator 228) may be then returned to the line 200′ and/or the first compressor 184 for recirculation within the first cooling circuit 176. In that manner, the first coolant may go through one or more subsequent cycles of compression, condensation, expansion, and evaporation, for the attainment and maintenance of a relatively low cabin temperature.

Now, with regard to a working of the second cooling system 234, and as with the working of the first cooling system 230, the second cooling system 234 of the air conditioning system 168 may facilitate or urge passage of the second coolant through (e.g., sequentially through) a cycle of compression, condensation, expansion, and evaporation. In so doing, conditioned air flow (e.g., cooled air flow) may be generated, e.g., at the second evaporator 232, and then said cooled air flow may be supplied into the interior volume 164 of the operator cabin 128, and accordingly, a temperature within the interior volume 164 of the operator cabin 128 may be reduced and accordingly conditioned.

To this end, during operations, the second compressor 204 may be driven or powered by the second energy source 148 or the electrical energy source 148′ of the machine 100, and may receive the second coolant (e.g., in a vaporized form) from line 220′. The second compressor 204 may compress or pressurize the second coolant up to a suitable pressure. Then, the second condenser 208 may receive the pressurized or compressed second coolant from the second compressor 204 through line 220″ and may function to condense the pressurized or compressed second coolant, e.g., to either a liquid phase or a saturated liquid-vapor phase. The condensation at the second condenser 208 may occur as an air flow, generated by the second condenser fan set 212, may pass through and across the second condenser 208. Also, as with the second compressor 204, the second condenser fan set 212 may be driven or powered by the second energy source 148 or the electrical energy source 148′.

The second expansion valve 216 may receive the condensed second coolant from the second condenser 208 through line 220′″ and may expand the condensed second coolant to lower a temperature of the second coolant at the second expansion valve 216, thus cooling down the condensed second coolant. A resulting expanded second coolant may be then received by the second evaporator 232 of the cooling arrangement 224. As the second evaporator 232 may also receive the air flow from the blowers 236, the second evaporator 232 may function to evaporate or vaporize the expanded second coolant, in turn allowing the vaporized second coolant to carry heat energy away from the air flow (or from the second portion of the air flow) passing through the second evaporator 232. In some embodiments, a drier (e.g., a second drier 252) may be present or included in the second cooling circuit 180. The second drier 252 may be configured to remove or reduce moisture present in the second coolant before the second coolant moves into the second expansion valve 216.

With regard to the second evaporator 232, as heat energy may be carried away by the vaporized first coolant from the air flow, an ensuing cooled air flow may be generated at the second evaporator 232. This cooled air flow may be routed and supplied to the interior volume 164 of the operator cabin 128 for lowering the temperature of the operator cabin 128. In some embodiments, the cooled air flow generated at the second evaporator 232 may be sourced from the air present with the interior volume 164 of the operator cabin 128 itself. In other words, air sourced from the interior volume 164 of the operator cabin 128 may be forced through the second evaporator 232 for the generation of the cooled air flow, and the said cooled air flow, as delivered into the operator cabin 128, may be further recirculated and drawn back (e.g., by a continuous working action of the blowers 236) into the second evaporator 232 such that the cooled air can further undergo (e.g., repeatedly undergo) cooling at the second evaporator 232. By way of such recirculation of cabin air, air within the interior volume 164 of the operator cabin 128 can be cooled and/or conditioned.

It may be noted that the vaporized volume of the second coolant generated at the second evaporator 232 (in concomitance to the generation of the cooled air flow at the second evaporator 232) may be then returned to the line 220′ and/or the second compressor 204 for recirculation within the second cooling circuit 180. In that manner, the second coolant may go through one or more subsequent cycles of compression, condensation, expansion, and evaporation, for the attainment and maintenance of a relatively low cabin temperature.

The first cooling system 230 and the second cooling system 234, being powered by separate and independent energy sources, i.e., respectively by the first energy source 140 and the second energy source 148, allows the first cooling system 230 and the second cooling system 234 to be controlled separately. In other words, the first cooling system 230 and the second cooling system 234 may be activated and deactivated (e.g., though suitable input devices present within the operator cabin 128) independently of each other. Therefore, in situations where one of the first energy source 140 and the second energy source 148 is in an inactive state and the other of the first energy source 140 and the second energy source 148 is in an active state, the cooling system 230, 234 associated with the active energy source 140, 148 may be operated to ensure that the operator cabin 128 remains conditioned and cooled appropriately.

As an example scenario, during an exemplary work cycle of the machine 100 at the worksite 104, if the machine 100 were to receive the payload 112 into the dump body 108, the machine 100 may be positioned stationarily or retained immobile for a period on the ground surface 144 (e.g., at a load location) to receive an influx of the payload 112. During such a period, if it is desired that the first energy source 140 (which may include the internal combustion engine 140′) be switched to the inactive state, e.g., to prevent idling, reduce engine emissions, and/or mitigate fuel consumption, the first cooling system 230 may become inoperative as well for the period. This is because the first compressor 184 and the first condenser fan set 192 of the first cooling system 230 may be power dependent on the first energy source 140.

However, as the second energy source 148 (which may be different from the first energy source 140 and exemplarily includes the electrical energy source 148′) can remain active during the period and because the second cooling system 234 can source power from said second energy source 148 during the period, the second cooling system 234 can be operated during this period. By way of an operation of the second cooling system 234 during this period, the second evaporator 232 may receive the second coolant (e.g., in a cooled down state) from the second cooling circuit 180 to facilitate the second heat transfer from the second portion of the air flow to the second coolant as the second evaporator 232 provides passage to the second portion of the air flow therethrough (see direction, A). The second portion of the air flow cooled at the second evaporator 232 may be urged and routed into the interior volume 164 of the operator cabin 128, thereby conditioning and cooling the operator cabin 128 during the period. In that manner, the cooling arrangement 224 and/or the overall air conditioning system 168 conditions air within the interior volume 164 of the operator cabin 128 of the machine 100 during the period.

At the lapse of the period and/or once the first energy source 140 is switched to the active state, the first cooling system 230 may be returned to the operative state as well, while the second cooling system 234 may be switched to inoperative state so as to save second electrical source power or battery power. Effectively, the cooling arrangement 224 and/or the overall air conditioning system 168 is able condition air within the interior volume 164 of the operator cabin 128 of the machine 100 even when one of the first energy source 140 (e.g., the internal combustion engine 140′) or second energy source 148 (e.g., the electrical energy source 148′) is inactive. In effect, one cooling system serves as back-up for the other cooling system. This enhances and/or retains operator comfort across multiple stages of work cycles at the worksite 104.

Although the above description discusses separate or independent operations of the first cooling system 230 and the second cooling system 234, in some embodiments, the first cooling system 230 and the second cooling system 234 may also operate together or simultaneously with each other. A manner of functioning of the first cooling system 230 and the second cooling system 234, when operating simultaneously or together may remain unchanged to the independent operations of the first cooling system 230 and the second cooling system 234 described above. It may be noted that during the active state of one or more of the first cooling system 230 (or the first cooling circuit 176) and the second cooling system 234 (or the second cooling circuit 180), the heating circuit 244 may be in an inactive state, but the heat exchanger 240 may still be able to trap water molecules present in the air flow (e.g., cooled air flow passing in from one or more of the first evaporator 228 and the second evaporator 232) as the heat exchanger 240 may be positioned relatively downstream to the first evaporator 228 and the second evaporator 232. In so doing, the heat exchanger 240 helps keep a humidity level in the interior volume 164 of the operator cabin 128 in check and/or in control. In some embodiments, each of the first evaporator 228, the second evaporator 232, and the heat exchanger 240, may be assembled, arranged, and/or integrated, into the common confinement or structure 238.

The integration of the first evaporator 228 and the second evaporator 232 (and optionally the heat exchanger 240) into a common confinement or structure (e.g., see structure 238) allows the air conditioning system 168 to be space efficient within the already limited confines of the interior volume 164 of the operator cabin 128—limited confines of the operator cabin is particularly applicable if the corresponding machine, i.e., the machine 100, were an underground work machine. Further, such integration is devoid of complex fluid lines and/or layouts. Moreover, the integration of the first evaporator 228 and the second evaporator 232 (and optionally the heat exchanger 240) generally requires a single set of blowers (e.g., blowers 236) to be used, thereby making the air conditioning system 168 less bulky, while also serving the purpose of cooling the interior volume 164 of the operator cabin 128 when one of the first energy source 140 or the second energy source 148 is inactive.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

The following is a current listing of the claims:

1. A cooling arrangement for conditioning air within a cabin of an underground work machine, the cooling arrangement comprising:
one or more blowers to generate an air flow;
a first evaporator configured to provide passage to a first portion of the air flow and receive a first coolant from a first cooling circuit to facilitate a first heat transfer from the first portion of the air flow to the first coolant as the first portion of the air flow passes through the first evaporator; and
a second evaporator configured to provide passage to a second portion of the air flow and receive a second coolant from a second cooling circuit different from the first cooling circuit to facilitate a second heat transfer from the second portion of the air flow to the second coolant as the second portion of the air flow passes through the second evaporator, wherein
a receipt of the first coolant into the first evaporator to facilitate the first transfer and a receipt of the second coolant into the second evaporator to facilitate the second transfer occurs either independently of each other or simultaneously with each other for supplying conditioned air flow into the cabin to cool the cabin.

2. The cooling arrangement of claim 1, wherein the first evaporator and the second evaporator are arranged serially with respect to each other to allow the air flow to sequentially pass through each of the first evaporator and the second evaporator.

3. The cooling arrangement of claim 1, wherein the first evaporator is positioned downstream to the second evaporator along a direction of the air flow generated by the one or more blowers.

4. The cooling arrangement of claim 1, further including one or more heat exchangers configured to receive a third coolant correspondingly from one or more heating circuits to selectively heat the air flow as the air flow passes therethrough.

5. The cooling arrangement of claim 4, wherein the one or more heat exchangers are positioned downstream of each of the first evaporator and the second evaporator along a direction of the air flow generated by the one or more blowers, and wherein each of the first evaporator, the second evaporator, and the one or more heat exchangers, is integrated into a common structure.

6. The cooling arrangement of claim 1, wherein
the first cooling circuit includes a first compressor to pressurize the first coolant, the first compressor configured to be powered by a first energy source, and
the second cooling circuit includes a second compressor to pressurize the second coolant, the second compressor configured to be powered by a second energy source different from the first energy source.

7. The cooling arrangement of claim 6, wherein the first energy source includes an internal combustion engine and the second energy source includes an electrical energy source.

8. An air conditioning system for a cabin of an underground work machine, the air conditioning system comprising:
a first cooling circuit to route a first coolant;
a second cooling circuit to route a second coolant, the second cooling circuit being different from the first cooling circuit; and
a cooling arrangement for conditioning air within the cabin of the underground work machine, the cooling arrangement including:
one or more blowers to generate an air flow;
a first evaporator configured to provide passage to a first portion of the air flow and receive the first coolant to facilitate a first heat transfer from the first portion of the air flow to the first coolant as the first portion of the air flow passes through the first evaporator; and
a second evaporator configured to provide passage to a second portion of the air flow and receive the second coolant to facilitate a second heat transfer from the second portion of the air flow to the second coolant as the second portion of the air flow passes through the second evaporator, wherein
a receipt of the first coolant into the first evaporator to facilitate the first transfer and a receipt of the second coolant into the second evaporator to facilitate the second transfer occurs either independently of each other or simultaneously with each other for supplying conditioned air flow into the cabin to cool the cabin.

9. The air conditioning system of claim 8, wherein the first evaporator and the second evaporator are arranged serially with respect to each other to allow the air flow to sequentially pass through each of the first evaporator and the second evaporator.

10. The air conditioning system of claim 8, wherein the first evaporator is positioned downstream to the second evaporator along a direction of the air flow generated by the one or more blowers.

11. The air conditioning system of claim 8 further including one or more heat exchangers configured to receive a third coolant correspondingly from one or more heating circuits to selectively heat the air flow as the air flow passes therethrough.

12. The air conditioning system of claim 11, wherein the one or more heat exchangers are positioned downstream of each of the first evaporator and the second evaporator along a direction of the air flow generated by the one or more blowers and wherein each of the first evaporator, the second evaporator, and the one or more heat exchangers, is integrated into a common structure.

13. The air conditioning system of claim 8, wherein
the first cooling circuit includes a first compressor to pressurize the first coolant, the first compressor configured to be powered by a first energy source, and
the second cooling circuit includes a second compressor to pressurize the second coolant, the second compressor configured to be powered by a second energy source different from the first energy source.

14. The air conditioning system of claim 13, wherein the first energy source includes an internal combustion engine and the second energy source includes an electrical energy source.

15. An underground work machine, comprising:
a main frame;
a cabin supported on the main frame and configured to station one or more operators therein;
an air conditioning system for the cabin, the air conditioning system including:
a first cooling circuit to route a first coolant;
a second cooling circuit to route a second coolant, the second cooling circuit being different from the first cooling circuit; and
a cooling arrangement for conditioning air within the cabin, the cooling arrangement including:
one or more blowers to generate an air flow;
a first evaporator configured to provide passage to a first portion of the air flow and receive the first coolant to facilitate a first heat transfer from the first portion of the air flow to the first coolant as the first portion of the air flow passes through the first evaporator; and
a second evaporator configured to provide passage to a second portion of the air flow and receive the second coolant to facilitate a second heat transfer from the second portion of the air flow to the second coolant as the second portion of the air flow passes through the second evaporator, wherein
a receipt of the first coolant into the first evaporator to facilitate the first transfer and a receipt of the second coolant into the second evaporator to facilitate the second transfer occurs either independently of each other or simultaneously with each other for supplying conditioned air flow into the cabin to cool the cabin.

16. The underground work machine of claim 15, wherein the first evaporator and the second evaporator are arranged serially with respect to each other to allow the air flow to sequentially pass through each of the first evaporator and the second evaporator.

17. The underground work machine of claim 15, wherein the first evaporator is positioned downstream to the second evaporator along a direction of the air flow generated by the one or more blowers.

18. The underground work machine of claim 15, further including one or more heat exchangers configured to receive a third coolant correspondingly from one or more heating circuits to selectively heat the air flow as the air flow passes therethrough,
wherein the one or more heat exchangers are positioned downstream of each of the first evaporator and the second evaporator along a direction of the air flow generated by the one or more blowers, and
wherein each of the first evaporator, the second evaporator, and the one or more heat exchangers, is integrated into a common structure.

19. The underground work machine of claim 15 further including a first energy source and a second energy source different from the first energy source, wherein
the first cooling circuit includes a first compressor to pressurize the first coolant, the first compressor configured to be powered by the first energy source, and
the second cooling circuit includes a second compressor to pressurize the second coolant, the second compressor configured to be powered by the second energy source.

20. The air conditioning system of claim 19, wherein the first energy source includes an internal combustion engine and the second energy source includes an electrical energy source.
